(19) United States
(12) Patent Application Publication
(10) Pub. No.: US 2017/0046278 A1
(43) Pub. Date: Feb. 16, 2017

(54) METHOD AND APPARATUS FOR UPDATING REPLACEMENT POLICY INFORMATION FOR A FULLY ASSOCIATIVE BUFFER CACHE

(71) Applicant: QUALCOMM Incorporated, San Diego, CA (US)

(72) Inventors: Robert Douglas CLANCY, Cary, NC (US); Gaurav MEHTA, Morrisville, NC (US); Michael Scott MCILVAINE, Raleigh, NC (US); William Robert FLEDERBACH, Raleigh, NC (US)

(21) Appl. No.: 15/083,978

(22) Filed: Mar. 29, 2016

Related U.S. Application Data
(60) Provisional application No. 62/205,527, filed on Aug. 14, 2015.

(51) Int. Cl. G06F 12/12; G06F 12/08

(52) U.S. Cl. CPC G06F 12/123; G06F 12/0897; G06F 12/0864; G06F 12/0891; G06F 2212/1021; G06F 2212/60; G06F 2212/69

(57) ABSTRACT

Techniques and apparatus are provided for updating replacement policy information for a fully associative buffer cache. A method is provided that generally includes updating replacement policy information for entries in a second cache memory based on hits indicating corresponding set-matching entries are present in the first cache memory, and evicting entries from the second cache memory based on the updated replacement policy information.

### CROSS-REFERENCE TO RELATED APPLICATION & PRIORITY CLAIM

This application claims benefit of and priority to U.S. Provisional Patent Application Ser. No. 62/205,527, filed Aug. 14, 2015, which is herein incorporated by reference in its entirety for all applicable purposes.

### BACKGROUND

Field of the Disclosure

Aspects disclosed herein relate to the field of computer microprocessors (also referred to herein as processors). More specifically, aspects disclosed herein relate to using a fully associative buffer cache for increased variable associativity of a main cache.

Description of Related Art

Modern processors conventionally rely on caches to improve processing performance. Caches work by exploiting temporal and spatial locality in the instruction streams and data streams of the workload. A portion of the cache is dedicated to storing cache tag arrays. Cache tags store the address of the actual data fetched from the main memory. To determine if there is a hit or a miss in the cache, bits of the tag can be compared against the probe address. A cache can be mapped to system memory. Increased cache associativity may increase hit rate for higher performance and fewer number memory searches, but may require a bigger array resulting in a larger area and a larger number of locations to search.

A cache (e.g., cache memory) is used by a central processing unit (CPU) (e.g., a processor) to reduce the average time to access data from main memory. The cache is a smaller, faster memory which stores copies of data from frequently used main memory locations. Most CPUs have different independent caches, including instruction and data caches, where the data cache is usually organized as a hierarchy of more cache levels (e.g., L1, L2, etc.).

Data is transferred between the main memory and the cache in blocks of fixed size, called cache lines. When a cache line is copied from the main memory into the cache, a cache entry is created. The cache entry will include the copied data as well as the requested memory location (e.g., referred to as a tag).

When the processor is to read from or write to a location in main memory, the processor first checks (e.g., searches) for a corresponding entry (e.g., a set-matching entry) in the cache to determine whether a copy of that data is in the cache. The cache checks for the contents of the requested memory location in any cache lines that might contain that address. If the processor finds that the desired memory location is found in the cache a cache “hit” has occurred; and if the processor does not find the memory location in the cache, a cache “miss” has occurred. In the case of a cache miss, the cache allocates a new entry and copies in data from main memory; then the request is fulfilled from the contents of the cache. In the case of a cache hit, the processor reads from or writes to the cache, which is much faster than reading from or writing to main memory. Thus, a cache can speed up how quickly a read or write operation is performed.

The proportion of accesses that result in a cache hit is known as the hit rate, and can be a measure of the effectiveness of the cache for a given program or algorithm. Read misses delay execution because data is transferred from memory, which is much slower than reading from the cache. In order to make room for the new entry on a cache miss, the cache may have to evict one of the existing entries. The heuristic that the cache uses to choose the entry to evict is sometimes referred to as the replacement policy.

The replacement policy decides where in the cache a copy of a particular entry of main memory will go. If the replacement policy is free to choose any entry in the cache to hold the copy, the cache is called fully associative. If each entry in main memory can go in just one place in the cache, the cache is direct mapped. A least-recently used (LRU) replacement policy replaces the least recently accessed entry. A LRU replacement policy can keep track of hits to entries in order to know how recently an entry has been hit. Thus, the entry that has not been hit for the longest period is the least recently used entry and is the entry and the LRU replacement policy will evict that entry if there is a miss to copy the new entry at that location.

Associativity can be trade-off between power, area, and hit rate. For example, since fully associativity allows any entry to be replaced, then every entry must be searched. For example, if there are ten places to which the replacement policy can map a memory location, then to check if that location is in the cache, ten cache entries will be searched. Checking more locations takes more power and chip area, and potentially more time. On the other hand, caches with more associativity may have fewer misses (i.e., a higher hit rate), so that the processor spends less time reading from the slow main memory, but means a bigger array and an increased number of locations that are searched.

Accordingly, techniques for increased cache associativity using smaller area and power consumption are desirable.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly.

In one aspect, an apparatus is provided. The apparatus generally includes a first cache memory; a second cache memory; and at least one processor configured to: update replacement policy information for entries in the second cache memory based on hits indicating corresponding set-matching entries are present in the first cache memory, and evict entries from the second cache memory based on the updated replacement policy information.

In another aspect, a method is provided. The method generally includes updating replacement policy information for entries in a second cache memory based on hits indicating corresponding set-matching entries are present in a first cache memory, and evicting entries from the second cache memory based on the updated replacement policy information.

In yet another aspect, an apparatus is provided. The apparatus generally includes means for updating replacement policy information for entries in a second cache memory based on hits indicating corresponding set-matching entries are present in a first cache memory, and means for evicting entries from the second cache memory based on the updated replacement policy information

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE SEVERAL VIEWS OF THE DRAWINGS

So that the manner in which the above recited aspects are attained and can be understood in detail, a more particular description of aspects of the disclosure, briefly summarized above, may be had by reference to the appended drawings.

It is to be noted, however, that the appended drawings illustrate only aspects of this disclosure and are therefore not to be considered limiting of its scope, for the disclosure may admit to other aspects.

FIG. 1 illustrates an example processor having a main cache and a fully associative buffer cache, in accordance with certain aspects of the present disclosure.

FIG. 2 is an example schematic illustrating entries stored on the main cache, in accordance with certain aspects of the present disclosure.

FIG. 3 is a example schematic illustrating entries stored on the fully associative buffer cache, in accordance with certain aspects of the present disclosure.

FIG. 4 is a flow chart illustrating example operations to increase main cache associativity using a fully associative buffer cache, in accordance with certain aspects of the present disclosure.

FIG. 4A illustrates example means capable of performing the operations set forth in FIG. 4.

FIG. 5 is an example flow chart illustrating a method for updating a replacement policy for a fully associative buffer cache based on hits in the main cache, in accordance with certain aspects of the present disclosure.

FIG. 6 is an example block diagram illustrating a computing device integrating a processor configured to increase associativity of a main cache using a fully associative buffer cache, in accordance with certain aspects of the present disclosure.

### DETAILED DESCRIPTION

Aspects disclosed herein use a fully associative buffer cache to increase variable associativity of the main cache. In aspects, when a search operation is performed, the main cache (e.g., a set associative cache) and the fully associative buffer cache can be searched in parallel. If an entry in the main cache hits, the replacement policy (e.g., a least recently used (LRU) replacement policy) for the fully associative buffer cache can be updated, for example, by setting a corresponding set-matching entry in the fully associative buffer cache as a most recently used (MRU) entry. In this manner, the fully associative buffer functions as an extension of the main cache and increases associativity of the main cache.

Aspects are provided herein for using a fully associative buffer cache to achieve increased variable associativity of the main cache. Sets that have more activity can be dynamically detected and expanded associativity can be enabled for those sets. For example, replacement policy information for the fully associative buffer cache may be updated based on hits in the main cache for those sets, in order to bias the fully associative buffer cache away from evicting corresponding to sets in the main cache which have recently had activity or have been hit.

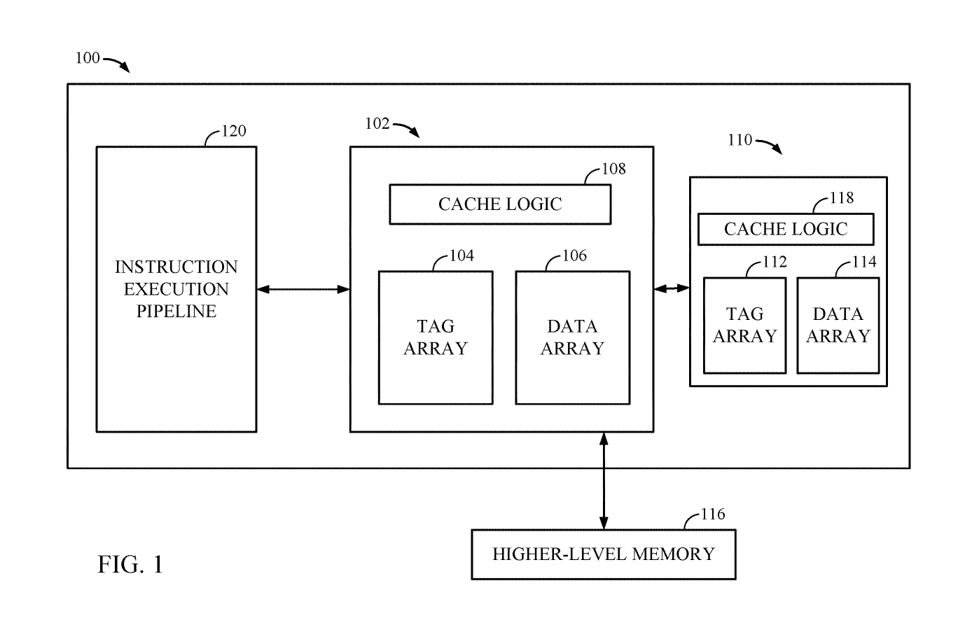

FIG. 1 illustrates a processor 100 (e.g., a central processing unit (CPU), a graphics processing unit (GPU), or other processor) that provides a fully associative buffer cache for increased variable associativity on the main cache, in accordance with certain aspects of the present disclosure. As shown in FIG. 1, the processor 100 may include an instruction execution pipeline 120 which executes instructions. The instruction execution pipeline 120 may be a superscalar design, with multiple parallel pipelines, each of which includes various non-architected registers (not pictured), and one or more arithmetic logic units (also not pictured). As shown in FIG. 1, the processor 100 may also include a main cache 102 (also referred to as a main cache memory 102), which stores lines of data from one or more higher levels of memory 116. The higher levels of memory 116 may include, without limitation, higher level caches and/or main (system) memory. Generally, the processor 100 may include numerous variations, and the processor 100 shown in FIG. 1 is for illustrative purposes and should not be considered limiting of the disclosure.

In one aspect, the processor 100 may be disposed on an integrated circuit (IC) including the instruction execution pipeline 120, the main cache 102, and the fully associative buffer cache 110. In another aspect, the main cache 102 and/or fully associative buffer cache 110 may be located on a separate integrated circuit from an integrated circuit including the processor 100.

As shown in FIG. 1, the main cache 102 may include cache logic 108, a tag array 104, and a data array 106. The cache logic 108 generally controls operation of the main cache 102, such as determining (e.g., detecting) whether cache hits or misses occur in a particular operation. In some examples, the cache logic 108 may be implemented in hardware, software, or both. The tag array 104 is generally configured to store the addresses of data stored in the main cache 102. The data array 106 stores the data of the cache lines. In at least one aspect, the tag array 104 and/or the data array 106 may be implemented as a content addressable memory (CAM) structure. The cache logic 108 may operate according to a replacement policy, for example, based on a set-associative or directly mapped policy.

According to certain aspects, as shown in FIG. 1, the processor 100 may include a fully associative buffer cache 110. The fully associative buffer cache 110 may include cache logic 118, tag array 112, and data array 114. In an aspect, the cache logic 118 may operate according to a replacement policy. In some aspects, the replacement policy for the fully associative buffer cache 110 may be a fully associative least recently used (LRU) replacement policy; however, other replacement policies may also be used which may not be a pure LRU policy.

In operation, the processor 100 may seek to determine (e.g., to detect) whether data located in one of the higher levels of memory 116 is present within the main cache 102 and/or the fully associative buffer cache 110, for example, by searching the main cache 102 and the buffer cache 110 in parallel. The buffer cache 110 may be a fully associative buffer and may have the same cache entry structure as the main cache 102. The fully associative buffer cache 110 may be smaller than the main cache 102 and, thus, may consume less area and power than the main cache 102.

The fully associative buffer cache 110 may be looked up (i.e., searched) in parallel with the main cache 102 and generate hits and/or misses in the same cycle as the main cache 102. Thus, with respect to searches, the fully associative buffer cache 110 may act as an extension of the main cache 102.

According to certain aspects, the replacement policy information for the replacement policy used by the fully associative buffer cache 110 can be updated based on hits and/or misses occurring in the main cache 102. For example, the replacement policy used by the fully associative buffer cache 110 may look at (e.g., detect) which set in the main cache 102 is being hit and mark the corresponding set-matching entry for the set in the fully associative buffer as the most recently used (MRU) entry. Thus, for a hit in the main cache 102, a corresponding entry in the fully associative buffer cache 110 may be marked as a MRU entry by the cache logic 118.

The replacement policy used in the fully associative buffer cache 110 may evict entries of the fully associative buffer cache 110 based on how frequently or how recently the entry has been hit. For example, if using a pure LRU policy, when a miss occurs, the fully associative buffer cache 110 may evict the least recently used entries of the fully associative buffer cache 110. Thus, by updating the replacement policy information, for example by marking corresponding set-matching entries in the fully associative buffer cache 110 that hit in the main cache 102 (e.g., marking as MRU), the fully associative buffer cache 110 may be biased to evicting entries for main cache sets which are least recently used, thus providing increased associativity for sets which have been used most recently.

If there is a miss, an entry (e.g., a least recently used entry) may be evicted from the fully associative buffer cache 110 and a new entry may be written in the fully associative buffer cache 110. The evicted entry may be fed to the main cache 102. The evicted entry may depend on the particular replacement policy used by the cache logic 118 for the fully associative buffer cache 110. For example, for a pure LRU replacement policy, the LRU entry may be evicted for the new entry to be written. For other types of replacement policies, the evicted entry may not be the LRU entry.

This increase in associativity may be flexible depending on the code/data structure. For example, if code/data from one set is being used more often, the increased associativity may benefit that set, whereas if code/data from two sets is being accessed more often, the increased associativity may be shared between those two sets, and so on.

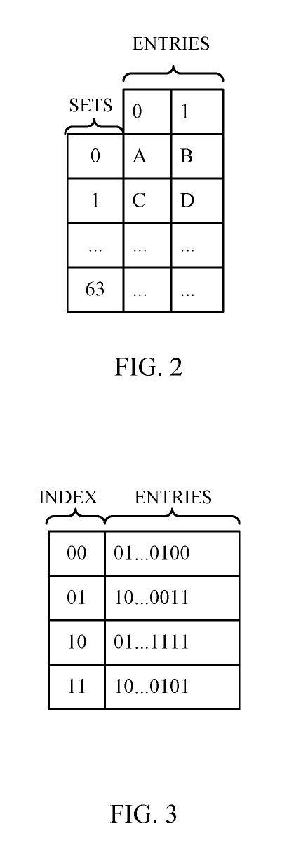

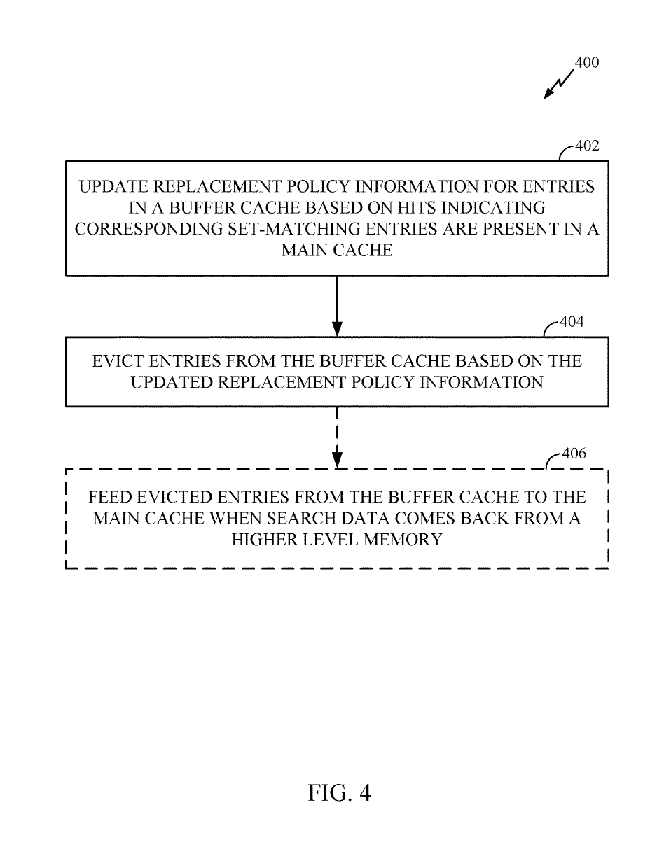

FIG. 2 is an example grid illustrating entries stored on the main cache 102 and FIG. 3 is an example grid illustrating entries stored on the fully associative buffer cache 110, in accordance with certain aspects of the present disclosure.

As shown in FIG. 2, each row in the grid may correspond to a set (e.g., 0, 1, . . . 63) and each column in the grid may be populated with entries for the sets. For example, as shown, set 0 may have entries A and B (ways 0 and 1) and set 1 may have entries C and D. As shown in FIG. 3, the fully associative buffer cache 110 can hold corresponding entries for the sets. For example, the fully associative buffer cache 110 may have an entry 0 corresponding to set 0, an entry 1 corresponding to set 3, an entry 2 corresponding to set 2, and an entry 3 corresponding to set 1.

In an example implementation, in order to increase the associativity of set 0, it would be desirable not to evict any entries in the main cache 102 (e.g., A, B) or the fully associative buffer cache 110 (e.g., entry 0) that correspond to set 0. For example, the corresponding entry for set 0 may not have hit recently in the fully associative buffer cache 110 but may hit in the main cache 102. In this case, in order to bias away from evicting the entry corresponding to set 0 in the fully associative buffer cache 110, the cache logic 118 for the fully associative buffer cache 110 may be updated with the replacement policy information regarding the recent hit to set 0 in the main cache 102. For example, the corresponding set-matching entry in the fully associative buffer cache 110 may be marked as most recently used.

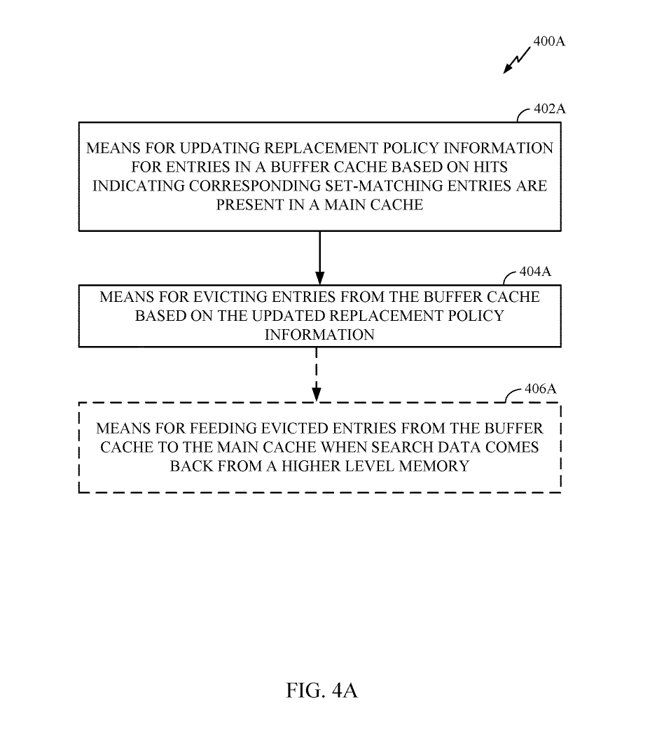

FIG. 4 is a flow chart illustrating example operations 400 to increase associativity of a main cache using a fully associative buffer cache, in accordance with certain aspect of the present disclosure. The operations 400 may be performed, for example, by a processor (e.g., processor 100). The operation 400 may begin, at 402, by updating replacement policy information (e.g., for a pure RLU replacement policy or other type of replacement policy) for entries in a second cache memory (e.g., a fully associative buffer cache 110) based on hits indicating corresponding set-matching entries are present in a first cache memory (e.g., main cache 102). At 404, entries from the second cache memory (e.g., LRU entries) are evicted based on the updated replacement policy information (e.g., that indicates entries as MRU in the second cache memory that correspond to the hits in the first cache memory). Optionally, at 406, the evicted entries from the second cache memory may be fed to the first cache memory (e.g., when the searched data comes back from the higher level memory).

According to certain aspects, the first cache memory comprises a set-associative cache memory or a direct mapped cache memory and the second cache memory comprises a fully associative cache memory that is smaller than the first cache memory. The first cache memory may be searched in parallel with the second cache memory and generate a hit or miss for the first cache memory and the second cache memory in a same search cycle. The method may include detecting a hit for an entry in the first cache memory; and updating the replacement policy information of the second cache memory to indicate a set-matching entry in the second cache memory corresponding to the hit as a most recently used entry (MRU) entry. Entries evicted from the second cache memory may be stored in the first cache memory. If a miss for an entry is in the first cache memory and the second cache memory is detected, a least recently used entry may be written in the second cache memory. In some cases, evicted entries can be fed back to the first cache memory, for example, in cases where the searched data comes back from the higher level memory.

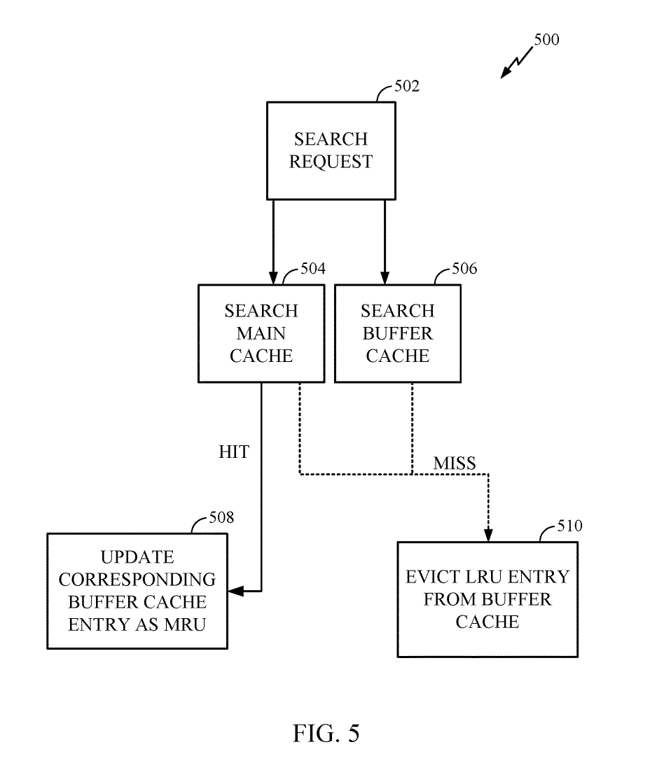

FIG. 5 is an example flow chart 500 illustrating a method for updating a replacement policy for a fully associative buffer cache based on hits in the main cache, in accordance with certain aspects of the present disclosure.

As shown in FIG. 5, at 502 a search request may be received. At 504 and 506, the main cache (e.g., main cache 102) and the buffer cache (e.g., fully associative buffer cache 110) can be searched in parallel for an entry corresponding to the requested search. If the search is a miss for both the main cache and the buffer cache, at 510 an entry may be evicted from the buffer cache. The evicted entry may be fed to the main cache. In aspects, the evicted entry may be fed back to the main cache only if the searched data comes back from the higher level memory. However, if the search is a hit for the main cache, replacement information for the corresponding buffer cache set-matching entry can be updated as most recent used.

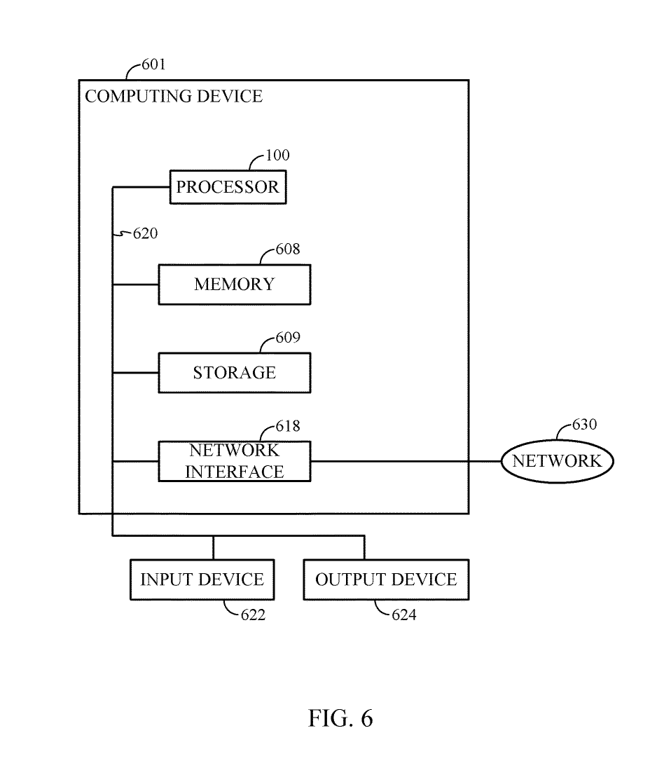

FIG. 6 is a block diagram illustrating a computing device 601 integrating the processor 100 configured to increase associativity of the main cache using a fully associative buffer cache, in accordance with certain aspects of the present disclosure. All of the apparatuses and methods depicted in FIGS. 1-5 may be included in or performed by the computing device 601. The computing device 601 may also be connected to other computing devices via a network 630. In general, the network 630 may be a telecommunications network and/or a wide area network (WAN). In a particular aspect, the network 630 is the Internet. Generally, the computing device 601 may be any device which includes a processor configured to implement a cache, including, without limitation, a desktop computer, a laptop computer, a tablet computer, and a smart phone.

The computing device 601 generally includes the processor 100 connected via a bus 620 to a memory 608, a network interface device 618, a storage 609, an input device 622, and an output device 624. The computing device 601 is generally under the control of an operating system (not shown). Any operating system supporting the functions disclosed herein may be used. The processor 100 is included to be representative of a single CPU, multiple CPUs, a single CPU having multiple processing cores, and the like. The network interface device 618 may be any type of network communications device allowing the computing device 601 to communicate with other computing devices via the network 630.

The storage 609 may be a persistent storage device. Although the storage 609 is shown as a single unit, the storage 609 may be a combination of fixed and/or removable storage devices, such as fixed disc drives, solid state drives, SAN storage, NAS storage, removable memory cards or optical storage. The memory 608 and the storage 609 may be part of one virtual address space spanning multiple primary and secondary storage devices.

The input device 622 may be any device for providing input to the computing device 601. For example, a keyboard and/or a mouse may be used. The output device 614 may be any device for providing output to a user of the computing device 601. For example, the output device 624 may be any conventional display screen or set of speakers. Although shown separately from the input device 622, the output device 624 and input device 622 may be combined. For example, a display screen with an integrated touch-screen may be used.

A number of aspects have been described. However, various modifications to these aspects are possible, and the principles presented herein may be applied to other aspects as well. The various tasks of such methods may be implemented as sets of instructions executable by one or more arrays of logic elements, such as microprocessors, embedded controllers, or IP cores.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by any suitable means capable of performing the operations, such as a processor, firmware, application specific integrated circuit (ASIC), gate logic/registers, memory controller, or a cache controller. Generally, any operations illustrated in the Figures may be performed by corresponding functional means capable of performing the operations.

For example, means 400A illustrated in FIG. 4A may be provided for performing the operations 400. For example, means 402A for updating replacement policy information for entries in a second cache memory based on hits indicating corresponding set-matching entries are present in a first cache memory may include a processor, such as the processor 100 of the computing device 601, the processor 100, instruction execution pipeline 120, the cache logic 108 of the main cache 102, and/or the cache logic 118 of the fully associative buffer cache 110. In addition, means for detecting, means for storing, and/or means for writing may include the processor 100.

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. Some or all such files may be provided to fabrication handlers who configure fabrication equipment using the design data to fabricate the devices described herein. Resulting products formed from the computer files include semiconductor wafers that are then cut into semiconductor die (e.g., the processor 100) and packaged, and may be further integrated into products including, but not limited to, mobile phones, smart phones, laptops, netbooks, tablets, ultrabooks, desktop computers, digital video recorders, set-top boxes and any other devices where integrated circuits are used.

In one aspect, the computer files form a design structure including the circuits described above and shown in the Figures in the form of physical design layouts, schematics, a hardware-description language (e.g., Verilog, VHDL, etc.). For example, design structure may be a text file or a graphical representation of a circuit as described above and shown in the Figures. Design process preferably synthesizes (or translates) the circuits described below into a netlist, where the netlist is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. In another aspect, the hardware, circuitry, and method described herein may be configured into computer files that simulate the function of the circuits described above and shown in the Figures when executed by a processor. These computer files may be used in circuitry simulation tools, schematic editors, or other software applications.

The implementations of aspects disclosed herein may also be tangibly embodied (for example, in tangible, non-transitory computer-readable features of one or more computer-readable storage media as listed herein) as one or more sets of instructions executable by a machine including an array of logic elements (e.g., a processor, microprocessor, microcontroller, or other finite state machine). The term “computer-readable medium” may include any medium that can store or transfer information, including volatile, nonvolatile, removable, and non-removable storage media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk or any other medium which can be used to store the desired information, a fiber optic medium, a radio frequency (RF) link, or any other medium which can be used to carry the desired information and can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such aspects.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. An apparatus comprising:
a first cache memory;
a second cache memory; and
at least one processor configured to:
update replacement policy information for entries in the second cache memory based on hits indicating corresponding set-matching entries are present in the first cache memory, and
evict entries from the second cache memory based on the updated replacement policy information.

2. The apparatus of claim 1, wherein the first cache memory comprises a set-associative cache memory or a direct mapped cache memory and the second cache memory comprises a fully associative cache memory that is smaller than the first cache memory.

3. The apparatus of claim 1, wherein the at least one processor is configured to:
detect a hit for an entry in the first cache memory; and
update the replacement policy information of the second cache memory to indicate an entry in the second cache memory corresponding to the hit as a most recently used entry (MRU) entry.

4. The apparatus of claim 1, wherein the at least one processor is further configured to store entries evicted from the second cache memory in the first cache memory.

5. The apparatus of claim 1, wherein the replacement policy information comprises least recently used (LRU) replacement policy information.

6. The apparatus of claim 5, wherein the at least one processor is configured to:
detect a miss for an entry in the first cache memory and the second cache memory, and write a least recently used entry in the second cache memory when search data comes back from a higher level memory.

7. The apparatus of claim 1, wherein the at least one processor is configured to search the first cache memory in parallel with the second cache memory and generate a hit or miss for the first cache memory and the second cache memory in a same search cycle.

8. A method comprising:
updating replacement policy information for entries in a second cache memory based on hits indicating corresponding set-matching entries are present in a first cache memory, and
evicting entries from the second cache memory based on the updated replacement policy information.

9. The method of claim 8, wherein the first cache memory comprises a set-associative cache memory or a direct mapped cache memory and the second cache memory comprises a fully associative cache memory that is smaller than the first cache memory.

10. The method of claim 8, further comprising:
detecting a hit for an entry in the first cache memory; and
updating the replacement policy information of the second cache memory to indicate an entry in the second cache memory corresponding to the hit as a most recently used entry (MRU) entry.

11. The method of claim 8, further comprising storing entries evicted from the second cache memory in the first cache memory.

12. The method of claim 8, wherein the replacement policy information comprises least recently used (LRU) replacement policy information.

13. The method of claim 12, further comprising:
detecting a miss for an entry in the first cache memory and the second cache memory, and
writing a least recently used entry in the second cache memory when search data comes back from a higher level memory.

14. The method of claim 8, further comprising searching the first cache memory in parallel with the second cache memory and generate a hit or miss for the first cache memory and the second cache memory in a same search cycle.

15. An apparatus comprising:
means for updating replacement policy information for entries in a second cache memory based on hits indicating corresponding set-matching entries are present in a first cache memory, and
means for evicting entries from the second cache memory based on the updated replacement policy information.

16. The apparatus of claim 15, wherein the first cache memory comprises a set-associative cache memory or a direct mapped cache memory and the second cache memory comprises a fully associative cache memory that is smaller than the first cache memory.

17. The apparatus of claim 15, further comprising:
means for detecting a hit for an entry in the first cache memory; and
means for updating the replacement policy information of the second cache memory to indicate an entry in the second cache memory corresponding to the hit as a most recently used entry (MRU) entry.

18. The apparatus of claim 15, further comprising means for storing entries evicted from the second cache memory in the first cache memory when search data comes back from a higher level memory.

19. The apparatus of claim 15, wherein the replacement policy information comprises least recently used (LRU) replacement policy information.

20. The apparatus of claim 19, further comprising:
means for detecting a miss for an entry in the first cache memory and the second cache memory, and
means for writing a least recently used entry in the second cache memory when search data comes back from a higher level memory.
